(19) United States
(12) Patent Application Publication
(10) Pub. No.: US 2019/0066032 A1
(43) Pub. Date: Feb. 28, 2019

(54) Robotic Vehicle Item Delivery Security System

(71) Applicant: QUALCOMM Incorporated, San Diego, CA (US)

(72) Inventors: Michael Franco TAVEIRA, San Diego, CA (US); Jonathan Paul DAVIS, Philadelphia, PA (US)

(21) Appl. No.: 15/682,796

(22) Filed: Aug. 22, 2017

(51) Int. Cl. G06Q 10/08; B64C 39/02; B65D 85/00; G05D 1/00

(52) U.S. Cl. CPC G06Q 10/083; B64C 39/024; B64C 2201/128; G05D 1/0088; B65D 85/00

(57) ABSTRACT

Various embodiments include methods, devices, and systems of securely delivering an item using a robotic vehicle and a security device that renders the item unusable without authorized removal there from or deactivation of the security device. The robotic vehicle may include a payload securing unit and a robotic vehicle processor. The payload securing unit may be configured to selectively hold the item or the security device while the item is secured to the security device. The robotic vehicle processor may be configured with processor-executable instructions to transport the item to the delivery destination while held by the payload securing unit and secured to the security device. The robotic vehicle may depart the delivery destination prior to receiving authorization to depart relating to the item.

### BACKGROUND

Robotic vehicle delivery of an item (cargo, package, payload, etc.) is relatively insecure in that there are limited ways to ensure that the item is delivered to the intended recipient or someone authorized to receive the item on behalf of the intended recipient. In many contemporary so-called “secure” delivery systems, once the robotic vehicle arrives at the intended delivery destination, the robotic vehicle does not release the item until the recipient (or authorized individual) authenticates the delivery in some way, such as using a pass-code or other form of authentication indicating the recipient is indeed authorized to receive the delivery. However, any time prior to this authentication (e.g., before arriving at the delivery destination or while waiting for the recipient), the item is not secure. For instance, the robotic vehicle may be attacked or captured while on route or while waiting to receive authorization to release the item. Once the robotic vehicle has been disabled, it may be relatively easy for someone to remove the item from the drone, thus bypassing any security.

### SUMMARY

Various embodiments include devices, and methods of securely delivering an item using a robotic vehicle and a security device that renders the item unusable without authorized removal there from or deactivation of the security device using an authenticating mechanism. Various embodiments include an item delivery system including a security device and a robotic vehicle. The robotic vehicle may include a payload securing unit, a robotic vehicle propulsion system, and a robotic vehicle processor. The payload securing unit may be configured to selectively hold the item or the security device while the item is secured to the security device. The robotic vehicle propulsion system may be configured to move the robotic vehicle from one location to a delivery destination. The robotic vehicle processor may be coupled to the payload securing unit and the robotic vehicle propulsion system. Also, the robotic vehicle may be configured with processor-executable instructions to transport the item to the delivery destination while held by the payload securing unit and secured to the security device and depart the delivery destination prior to receiving authorization to depart relating to the item. The robotic vehicle processor may be further configured with processor-executable instructions to activate the payload securing unit to release the item secured with the security device at the delivery destination and leave the item secured to the security device at the delivery destination.

In some embodiments, the security device may be a transport container configured to enclose the item therein. The transport container may include a lockable panel configured to open using the authenticating mechanism. The transport container may enclose the item in a compartment therein. The transport container may include a plurality of separate compartments, and at least one of the separate compartments may be configured to hold the item and at least one other of the separate compartments may be configured to hold a different item for delivery. The authenticating mechanism may include a first authenticating mechanism and a second authenticating mechanism, wherein the first authenticating mechanism opens one of the separate compartments and the second authenticating mechanism opens another of the separate compartments. The transport container may include at least one of a collapsible and foldable structure for reducing a size of the security device after removal of the item.

In some embodiments, the delivery system may include another security device secured to at least one other item for delivery. The other payload securing unit may be configured to selectively hold the at least one other item while the at least one other item is secured to the other security device. A release mechanism may be configured to selectively release at least one of the item and the other item. The security device may further include at least one of a user interface and a key-lock mechanism. The user interface may be coupled to a security device processor. The user interface may be configured to receive security data in the form of at least one of a signature, biometric identification, gesture, password, and access-code. The security device processor may be configured with processor-executable instructions to determine whether the received security data matches a predetermined code designated as the authenticating mechanism for removing the security device from the item. The key-lock mechanism may receive a physical key that may be used as the authenticating mechanism for removing the security device from the item.

In some embodiments, the security device may include a locator, an alert device, and a security device processor. The locator may be configured to gather position information of the security device. The alert device may indicate the security device has been moved more than a predetermined distance from a drop-off position at a delivery destination. The security device processor may be coupled to the locator and the alert device, and configured with processor-executable instructions to receive position information gathered by the locator. The processor-executable instruction may determine, based on the received position information, whether the security device has moved more than the predetermined distance from the drop-off position at the delivery destination. The movement may be detected by the locator after the robotic vehicle has departed from the delivery destination without the security device. The processor-executable instruction may also activate an alert in response to determining that the security device has moved more than the predetermined distance from the drop-off position. Activating the alert may be further in response to the security device processor determining that the item is still secured to the security device, and determining that the security device has not been unlocked since the robotic vehicle arrived at the delivery destination. The robotic vehicle departing the delivery destination prior to receiving authorization to depart relating to the item may include leaving the item secured to the security device at the delivery destination.

In some embodiments, the security device may include a tamper detector configured to detect at least one of an attempt to remove the security device from the item and tampering with the security device. The security device may include a propulsion sub-system for moving the security device from the delivery destination after the robotic vehicle departs from the delivery destination. In addition, the security device may include a sub-processor coupled to the propulsion sub-system and configured with processor-executable instructions to activate the propulsion sub-system to depart the delivery destination after the robotic vehicle has left from the delivery destination.

In some embodiments, the security device may be a security tag attached to an outer portion of the item, and the security tag may be configured to release the item upon using a valid authenticating mechanism. The security device may include a tamper-responsive device configured to disable, damage, and/or destroy the item, which may be in response to detecting tampering with or movement of the security tag. The payload securing unit may include a gripping mechanism for holding the item and a release mechanism for releasing the item.

Various embodiments include methods of delivering an item via the robotic vehicle, including transporting the item secured to a security device by the robotic vehicle carrying the item to a delivery destination, wherein the security device is removable from the item using a valid authenticating mechanism and is configured to render the item unusable without authorized removal or deactivation of the security device. The method may also include releasing the item and the security device secured thereto at the delivery destination. In addition, the robotic vehicle may be operated to depart from the delivery destination prior to receiving authorization to depart relating to the item, wherein when departing from the delivery destination the robotic vehicle leaves the item secured to the security device at the delivery destination.

Some embodiments may further include determining whether a presented authenticating mechanism, used to remove the security device from the item, is the valid authenticating mechanism after the robotic vehicle has departed from the delivery destination, and activating a release mechanism for releasing the item from the security device in response to determining the presented authenticating mechanism is the valid authenticating mechanism. The security device may be a security tag that releases the item upon using the valid authenticating mechanism. The method may further include determining at least one of whether tampering with the security device has occurred and whether the security has been moved more than a predetermined distance from a drop-off position at the delivery destination. The item may be damaged or rendered inoperable in response to determining that tampering with the security device has occurred or that the security has been moved more than the predetermined distance from the drop-off position. The security device may be a transport container enclosing the item therein. The transport container may enclose the item in a compartment therein. The transport container may include a plurality of separate compartments, and at least one of the separate compartments may be configured to hold the item and at least one other of the separate compartments is configured to hold a different item for delivery. The method may also include transmitting a delivery notification to a recipient of the item in response to the robotic vehicle departing from the delivery destination.

Some embodiments may include transporting at least one other item, secured to another security device, by the robotic vehicle carrying the at least one other item to the delivery destination. The other security device may be removable from the at least one other item using another authenticating mechanism and configured to make the at least one other item unusable without removal of the other security device. The robotic vehicle may depart from the delivery destination, leaving the at least one other item secured to the other security device, without waiting for authorization to depart relating to the other item, wherein when departing from the delivery destination the robotic vehicle. At least one of a pass-code or specifications for making a physical key may be transmitted to a recipient of the item to be delivered to the delivery destination. One of the pass-code or the physical key may be the valid authenticating mechanism needed to remove the security device from the item.

In some embodiments, movement may be detected away from a drop-off position at the delivery destination of the security device with the item secured thereto after the robotic vehicle has departed from the delivery destination without the security device. A determination may be made as to whether the security device has moved more than a predetermined distance from the drop-off position. An alert may be activated in response to determining that the detected movement moves the security device more than the predetermined distance from the drop-off position. Activating the alert may be in response to determining that the item is still secured to the security device and/or determining that the security device has not been unlocked since the robotic vehicle arrived at the delivery destination. Whether the security device has been tampered with may be detected after the robotic vehicle has departed from the delivery destination without the security device. In addition, an alert may be activated in response to determining that the security device has been tampered.

Further embodiments may include a robotic vehicle and/or a security device having various means for performing functions corresponding to the method operations discussed above. Further embodiments may include a non-transitory processor-readable storage medium having stored thereon processor-executable instructions configured to cause a processor of a robotic vehicle and/or a security device to perform various operations corresponding to the method operations discussed above. Further embodiments may include a processing device including a processor configured with processor-executable instructions configured to cause a robotic vehicle and/or a security device to perform various operations corresponding to the method operations discussed above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of the claims.

FIG. 1 is a diagram of a delivery sequence of a robotic vehicle securely delivering an item to a recipient, according to various embodiments.

FIG. 2A is a schematic side elevation diagram of a robotic vehicle holding a security device containing an item for delivery, according to various embodiments.

FIG. 2B is a schematic side elevation diagram of a robotic vehicle with the security device containing the item separating from the robotic vehicle, according to various embodiments.

FIG. 3 is a diagram illustrating components of a robotic vehicle suitable for use with various embodiments.

FIG. 4 is a schematic side elevation diagram of a robotic vehicle, in the form of a truck, holding a plurality of items for delivery, according to various embodiments.

FIG. 5 is a diagram illustrating components of a security device suitable for use with various embodiments.

FIG. 6 is a perspective view of a multi-compartment security device suitable for use with various embodiments.

FIG. 7 is a diagram illustrating components of a cage-like security device suitable for use with various embodiments.

FIG. 8 is a diagram illustrating components of a collapsible security device suitable for use with various embodiments.

FIG. 9 is a diagram of a security device in the form of a security tag suitable for use with various embodiments.

FIG. 10A is a schematic top view of a folded configuration of a security device that converts into a robotic vehicle suitable for use with various embodiments.

FIG. 10B is a schematic top view of a deployed configuration of a security device suitable for use with various embodiments.

FIG. 11 is a process flow diagram illustrating a method of delivering an item via a robotic vehicle, according to various embodiments.

FIG. 12 is a component diagram of a remote computing device, in the form of a wireless communication device, suitable for use with various embodiments.

FIG. 13 is a component diagram of another remote computing device, in the form of a server, suitable for use with the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include a system and method of securely delivering items via a robotic vehicle. A delivery robotic vehicle may transport and deliver an item that is attached to a security device. The security device may be a lockbox or a security tag attached to the item. The security device may be configured to be opened only by an authorized individual or entity (e.g., intended package recipient or authorized representative, or automated recovery system). The delivery robotic vehicle may be configured to transport and deliver the item with the security device attached. The robotic vehicle may depart the delivery destination, leaving behind the item locked by the security device. The security device may be configured to be opened/removed eventually by an individual or entity possessing a valid authenticating mechanism. The security device (i.e., the lockbox or security tag) may be retrieved later such as (but not limited to) being picked up in a future delivery, mailed back to the sender, dropped off at a collection facility, etc. Alternatively, if the individual or entity possessing the authenticating mechanism is present when the delivery robotic vehicle arrives at the delivery destination, the robotic vehicle may depart the delivery destination with the security device after the item is removed using the authenticating mechanism.

By locking an item for delivery within a security device, various embodiments enable delivery of items by a robotic vehicle without the vehicle having to wait for authorization before releasing the item. Not having to wait for the recipient or authorization to leave the item saves time and power that the robotic vehicle would otherwise use while waiting. In some instances, the power saved from not waiting may mean the difference between reaching the delivery destination or some return location. That is, saving power from not waiting may increase the effective delivery range of such delivery robotic vehicles.

The delivery system according to various embodiments is more secure than other systems or methods because if the robotic vehicle is disabled, destroyed, apprehended or otherwise prevented from completing the delivery (e.g., while on route to the delivery destination or waiting for authorization by a recipient at the delivery destination, etc.), unauthorized individuals are prevented or deterred from taking the item. The delivery system may reduce incentives to attack or hijack a delivery robotic vehicle. The delivery system also increases likelihood that someone finding a wayward delivery robotic vehicle will not tamper with the robotic vehicle or the secured item, as such a person would not be able to easily retrieve and keep the secured item.

As used herein, the terms “robotic vehicle” and “drone” refer to one of various types of vehicles including an onboard computing device configured to provide some autonomous or semi-autonomous capabilities. Examples of robotic vehicles include but are not limited to: aerial vehicles, such as an unmanned aerial vehicle (UAV); ground vehicles (e.g., an autonomous or semi-autonomous car, a vacuum robot, etc.); water-based vehicles (i.e., vehicles configured for operation on the surface of the water or under water); space-based vehicles (e.g., a spacecraft or space probe); and/or some combination thereof. In some embodiments, the robotic vehicle may be manned. In other embodiments, the robotic vehicle may be unmanned. In embodiments in which the robotic vehicle is autonomous, the robotic vehicle may include an onboard computing device configured to maneuver and/or navigate the robotic vehicle without remote operating instructions (i.e., autonomously), such as from a human operator (e.g., via a remote computing device). In embodiments in which the robotic vehicle is semi-autonomous, the robotic vehicle may include an onboard computing device configured to receive some information or instructions, such as from a human operator (e.g., via a remote computing device), and autonomously maneuver and/or navigate the robotic vehicle consistent with the received information or instructions. In some implementations, the robotic vehicle may be an aerial vehicle (unmanned or manned), which may be a rotorcraft or winged aircraft. For example, a rotorcraft (also referred to as a multirotor or multicopter) may include a plurality of propulsion units (e.g., rotors/propellers) that provide propulsion and/or lifting forces for the robotic vehicle. Specific non-limiting examples of rotorcraft include tricopters (three rotors), quadcopters (four rotors), hexacopters (six rotors), and octocopters (eight rotors). However, a rotorcraft may include any number of rotors.

As used herein, the term “item” refers to one or more articles that may be delivered as a unit. The item may include its own packaging or be delivered without packaging, aside from the security device, in accordance with various embodiments. For example, for delivery, the item may be placed directly inside a security device that is formed like a transport container (i.e., the container is a substitute for a cardboard parcel container). As another example, the item may be placed in a typical cardboard parcel container or the like with the parcel container placed within an inner chamber of the security device.

As used herein, the term “security device” refers to a mechanism that is configured to prevent or deter theft, tampering, or unauthorized removal of an item being delivered by a robotic vehicle. A security device may render the item unusable without authorized removal or deactivation of the security device using an authenticating mechanism. In particular, a security device may include a piece of mechanical and/or electronic equipment attached to or holding the item therein.

As used herein, the term “authenticating mechanism” refers to one or more devices and/or security data presented to the security device to verify the identity/presence of an authorized recipient of an item. For example, an authenticating mechanism may include one or more of a physical device, a user input or other security data input, or a combination thereof that is/are used to remove and/or separate an item from the security device. Physical devices may include (but are not limited to) a physical key, key card, token, proximity-based key/token (e.g., RFID tag with a digital certificate), and/or other devices. For instance, a user input may include a signature, biometric identification (e.g., finger print, face recognition, retinal scan, etc.), gesture (e.g., using gesture recognition), password/access-code (i.e., a predetermined code), etc. Other examples of security data inputs may include authentication information not directly communicated by an individual to the security device, such as through signaling (e.g., light, sound, vibrations, electrical impulse, or radio waves).

As used herein, the term “computing device” refers to an electronic device equipped with at least a processor. Examples of computing devices include processors within a security device, a robotic vehicle and/or mission management computer that are onboard the robotic vehicle, as well as remote computing devices communicating with the robotic vehicle configured to perform operations of the various embodiments. Computing devices may include wireless communication devices (e.g., cellular telephones, wearable devices, smart-phones, web-pads, tablet computers, Internet enabled cellular telephones, Wi-Fi® enabled electronic devices, personal data assistants (PDAs), laptop computers, etc.), personal computers, and servers. In various embodiments, computing devices may be configured with memory and/or storage. Additionally, computing devices referred to in various example embodiments may be coupled to or include wireless communication capabilities implementing various embodiments, such as network transceiver(s) and antenna(s) configured to establish a local area network (LAN) connection (e.g., Wi-Fi® transceivers).

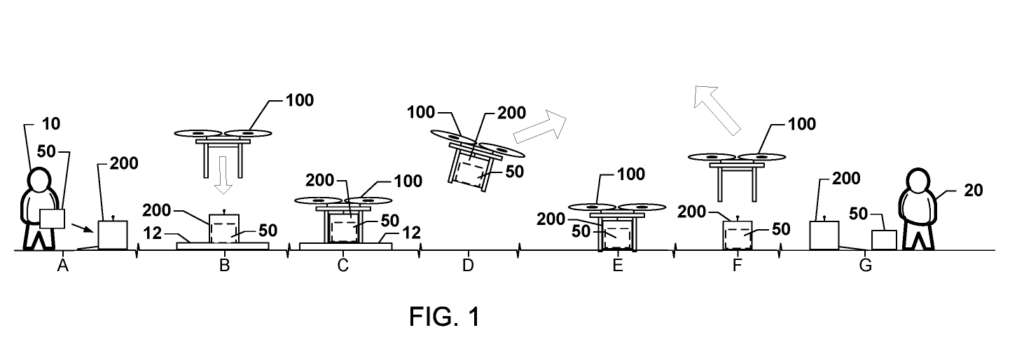

As illustrated in FIG. 1, a loading and delivery sequence may be performed to deliver an item 50 by a robotic vehicle 100 using a security device 200. The item 50 may be initially secured relative to the security device 200 in stage A. An individual 10 or automated system may secure the item 50 to the security device 200. For security devices that include an inner compartment, securing the item 50 to the security device 200 may include positioning or inserting the item 50 in that inner compartment, and optionally making sure the item 50 is stable and secure. In addition, any compartment panels or straps may be closed or secured. Alternative security devices that do not include an inner compartment may be secured to the item 50.

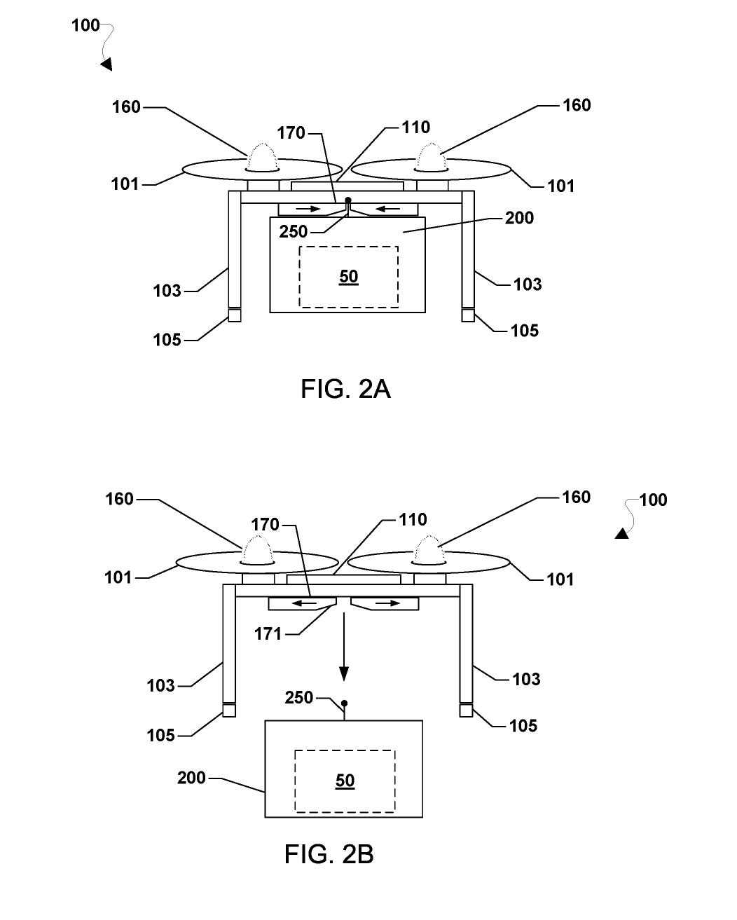

In stage B, the robotic vehicle 100 may be aligned for coupling with the security device 200. The robotic vehicle 100 may use its own propulsion to move to the security device 200 or the security device may be moved to the robotic vehicle 100 (e.g., the security device 200 may be manually or automatically coupled to the robotic vehicle 100 by the individual 10 and/or an automated system). Stage B illustrates the robotic vehicle 100 descending onto the security device 200, which is sitting on a loading platform 12. Once a payload securing unit (e.g., 170 in FIGS. 2A-2B) of the robotic vehicle 100 is aligned with a coupling element of the security device 200, the robotic vehicle 100 can drop and grasp the coupling element. Alternatively, the item 50 may be coupled to the security device 200 (e.g., loaded inside) after the security device 200 is attached to the robotic vehicle 100 (i.e., after stage B).

In stage C, the robotic vehicle 100 is already coupled the security device 200, which holds the item 50 therein. At this point, the robotic vehicle 100 may be ready to transport the item 50 to or at least toward a delivery destination associated with the item 50.

In stage D, the robotic vehicle 100 has begun transporting the item, secured by the security device 200, toward the delivery destination.

In stage E, the robotic vehicle 100 has arrived at the delivery destination and may be ready to release the security device 200 with the item 50 still secured therein. Although the robotic vehicle 100 is illustrated as having landed or at least stopped, the robotic vehicle 100 need not land or stop to release and thus deliver the security device 200 at the delivery destination. For instance, the robotic vehicle 100 may lower the security device 200 along with the item 50 (e.g., on a tether or the like) or the robotic vehicle 100 may jettison the security device 200 along with the item 50 (e.g., with a parachute or the like). In particular embodiments, the robotic vehicle 100 may release and thus deliver the security device 200 (along with the item 50) prior to receiving authorization to do so from a recipient or other authorized entity.

In stage F, the robotic vehicle 100 departs the delivery destination using its own propulsion system leaving behind the security device 200 securing the item 50 therein. The robotic vehicle 100 may depart in this way prior to receiving authorization to do so from the recipient or any other entity. In this way, the robotic vehicle 100 need not wait at the delivery destination to complete its part of the delivery process.

In stage G, a recipient 20 has arrived, or an automated recovery system has engaged, after the robotic vehicle 100 has left, and has used an authenticating mechanism to release and remove the item 50 from the security device 200.

Various embodiments may be implemented with a variety of robotic vehicles, configured to transport and deliver one or more items for delivery, an example of which is illustrated in FIGS. 2A and 2B. With reference to FIGS. 1-2B, the robotic vehicle 100 may be a robotic vehicle that may include rotors 101 and flight motors 160 that may be fixed to a frame 103 and landing skids 105 that may support a full weight of the robotic vehicle 100. In various embodiments, the robotic vehicle 100 may be configured to secure the item 50 with the security device 200 to the robotic vehicle 100. Parts of the frame 103 and landing skids 105 are disposed on both sides of a payload securing unit 170 that secures the security device 200, holding the item 50 therein, to the robotic vehicle 100. In some embodiments, the security device 200 is a transport container configured to enclose articles, such as the item 50, in a compartment therein. The frame 103 may be an open structure, such that portions of the security device 200 may extend beyond the frame 103 and below the landing skids 105.

The payload securing unit 170 may include a gripping and release mechanism, motor, and so on, that may be rated sufficiently to grasp and hold the security device 200. The payload securing unit 170 may include a motor that drives the gripping and release mechanism and other controls, which may be responsive to grip and release the security device 200. FIG. 2A illustrates the security device 200 gripped by the payload securing unit 170. Thus, the item 50 held within the security device 200 is secured relative to the robotic vehicle 100. In contrast, in FIG. 2B the payload securing unit 170 has released the security device 200, by expanding the gripping and release mechanism. Once released from the payload securing unit 170, the security device 200 and the item 50 may both separate, together, from the robotic vehicle 100.

Again with reference to FIGS. 1-2B, the payload securing unit 170 may be configured to grasp or re-grasp the security device 200. In this way, the robotic vehicle 100 may fly over to the security device 200, drop down over it, and line-up a guide funnel 171 of the payload securing unit 170 with a protruding coupling element 250 of the security device 200. For example, the protruding coupling element 250 may include a thin rigid rod, protruding from a surface of the security device, topped with a bulbous element (e.g., a ball) designed to be received and held in the payload securing unit 170. A lower portion of the payload securing unit 170 may include a funnel shape for guiding the protruding coupling element 250 into the payload securing unit. Alternatively, the thin rigid rod of the protruding coupling element 250, may be a flexible cable. As a further alternative, the payload securing unit 170 or another part of the robotic vehicle 100 may include a vision-based tracking system configured to align and guide a coupling with the security device 200 by the payload securing unit 170. The vision-based tracking system may use a pair of cameras on the robotic vehicle 100 for stereoscopic depth analysis and three-dimensional mapping. The vision-based tracking system may also use one or more markings, such as matrix barcodes, patterns, symbols, shapes, or the like, disposed on one or more outer portions of the security device 200. Different markings may be used to differentiate the various sides of the security device 200. In addition, the robotic vehicle 100 may use the dimensions or shape of the security device 200 to recognize and locate the security device 200, in addition to orienting and guiding a coupling therewith. A reflective strip (e.g., infrared or ultraviolet reflective) may be included on the security device 200, such as along edges, to facilitate the vision-based tracking system. Optionally, the payload securing unit 170 may include a larger housing structure configured to completely enclose the security device 200.

Additionally or alternatively, the payload securing unit 170 may include an electromagnetic lock, controlled by a processing device 110 of the robotic vehicle 100. For example, gripping elements of the payload securing unit 170 may include the electromagnetic lock. Alternatively, the payload securing unit 170 may generate a magnetic field configured to attract and hold a complementary surface on the security device 200 (e.g., the protruding coupling element 250 or a flat metallic plate). The processing device 110 may regulate an electric current used to open and/or close the electromagnetic lock. In other embodiments, the robotic vehicle 100 may be configured in any suitable manner for holding the security device 200 (along with the item 50) to allow transport thereof.

The robotic vehicle illustrated in FIGS. 1-2B is a quad copter-style horizontal rotor robotic vehicle (a.k.a. a “drone”), which may fly in any unobstructed horizontal and vertical direction or may hover in one place. A robotic vehicle may be configured with processing and communication devices that enable the robotic vehicle to navigate, such as by controlling the flight motors to achieve flight directionality and to receive position information and information from other system components including vehicle systems, package delivery service servers and so on. The position information may be associated with the current robotic vehicle position, the robotic vehicle delivery destination, or other locations associated with the robotic vehicle, the security device, and/or the item being delivered.

For ease of description and illustration, some details of the robotic vehicle 100 are omitted such as wiring, frame structure interconnects or other features that would be known to one of skill in the art. In various embodiments, the robotic vehicle 100 may have four rotors 101. However, more or fewer of the rotors 101 may be included.

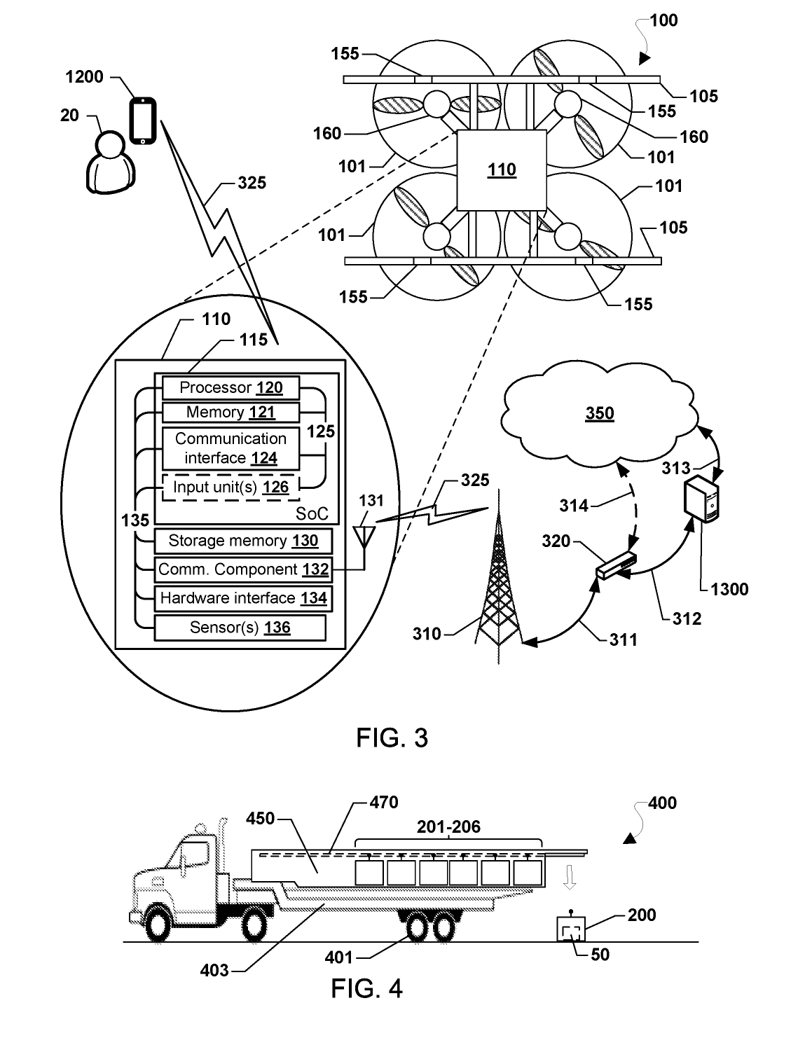

Various embodiments may be implemented within a variety of robotic vehicles configured to communicate with one or more communication networks, an example of which suitable for use with various embodiments is illustrated in FIG. 3. With reference to FIGS. 1-3, the robotic vehicle 100 may operate in connection with one or more of a mobile computing device 1200, a base station 310, a remote computing device 320, a remote server 1300, and a communication network 350.

The base station 310 may provide the wireless communication link 325, which may be a bi-directional link, such as through wireless signals to the robotic vehicle 100. The base station 310 may include one or more wired and/or wireless communications connections 311, 312, 313, 314 to the communication network 350. The communication network 350 may in turn provide access to other remote base stations over the same or another wired and/or wireless communications connection. The remote computing device 320 may be configured to control the base station 310, the robotic vehicle 100, and/or control wireless communications over a wide area network, such as providing a wireless access point and/or other similar network access points using the base station 310. In addition, the remote computing device 320 and/or the communication network 350 may provide access to a remote server 1300. The robotic vehicle 100 may be configured to communicate with the remote computing device 320 and/or the remote server 1300 for exchanging various types of communications and data, including location information, navigational commands, data inquiries, and mission data.

The terms “server” or “remote server” are used herein interchangeably to refer to any computing device capable of functioning as a server, such as a master exchange server, web server, and a personal or mobile computing device configured with software to execute server functions (e.g., a “light server”). Thus, various computing devices may function as a server 1300, such as any one or all of cellular telephones, smart-phones, web-pads, tablet computers, Internet enabled cellular telephones, wide area network (WAN) enabled electronic devices, laptop computers, personal computers, a computing device specific to the base station 310, the remote computing device 320, and similar electronic devices equipped with at least a processor, memory, and configured to communicate with a robotic vehicle. The server 1300 may be a dedicated computing device or a computing device including a server module (e.g., running an application that may cause the computing device to operate as a server). A server module (or server application) may be a full function server module, or a light or secondary server module (e.g., light or secondary server application). A light server or secondary server may be a slimmed-down version of server type functionality that can be implemented on a personal or mobile computing device, such as a smart phone, thereby enabling it to function as an Internet server (e.g., an enterprise e-mail server) to a limited extent, such as necessary to provide the functionality described herein.

Alternatively, the robotic vehicle 100 may be configured to communicate directly with the mobile computing device 1200 using the wireless communication link 325, which provides long-range wireless communications to receive instructions. The wireless communication link 325, may be established between an onboard antenna 131 of the communication component 132 and the mobile computing device 1200. The communication component 132 may be configured to receive GPS signals from a satellite or other signals used by the robotic vehicle 100. The mobile computing device 1200 may be a device located in a remote facility controlled by an operator of the robotic vehicle 100 or may be a device associated with a recipient 20 of the item (e.g., 50) being delivered. The mobile computing device 1200 may alternatively be a server associated with the package delivery service or operator of the robotic vehicle 100. The communication component 132 may support communications with multiple ones of the mobile computing devices 1200.

The robotic vehicle 100 may include a processing device 110 that is configured to monitor and control the various functionalities, sub-systems, and/or other components of the robotic vehicle 100. For example, the processing device 110 may be configured to monitor and control various functionalities of the robotic vehicle 100, such as any combination of modules, software, instructions, circuitry, hardware, etc. related to propulsion, navigation, power management, sensor management, and/or stability management.

The processing device 110 may house various circuits and devices used to control the operation of the robotic vehicle 100. For example, the processing device 110 may include a processor 120 that directs the control of the robotic vehicle 100. The processor 120 may include one or more processors configured to execute processor-executable instructions (e.g., applications, routines, scripts, instruction sets, etc.) to control flight, antenna usage, and other operations of the robotic vehicle 100, including operations of various embodiments. In some embodiments, the processing device 110 may include memory 121 coupled to the processor 120 and configured to store data (e.g., flight plans, obtained sensor data, received messages, applications, etc.). The processor 120 and memory 121, along with (but not limited to) additional elements such as a communication interface 124 and one or more input unit(s) 126, may be configured as or included in a system-on-chip (SoC) 115. The processing device 110 may include one or more hardware interface 134 for coupling to the SoC 115 or other components.

The processing device 110 may include more than one SoC 115 thereby increasing the number of processors 120 and processor cores. The processing device 110 may also include processors 120 that are not associated with the SoC 115. Individual processors 120 may be multi-core processors. The processors 120 may each be configured for specific purposes that may be the same as or different from other processors 120 of the processing device 110 or SoC 115. One or more of the processors 120 and processor cores of the same or different configurations may be grouped together. A group of processors 120 or processor cores may be referred to as a multi-processor cluster.

The terms “system-on-chip” or “SoC” as used herein refer to a set of interconnected electronic circuits typically, but not exclusively, including one or more processors (e.g., 120), a memory (e.g., 121), and a communication interface (e.g., 124). The SoC 115 may include a variety of different types of processors 120 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 115 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 115 may include one or more processors 120. The processing device 110 may include more than one SoC 115, thereby increasing the number of processors 120 and processor cores. The processing device 110 may also include processors 120 that are not associated with the SoC 115 (i.e., external to the SoC 115). Individual processors 120 may be multi-core processors. The processors 120 may each be configured for specific purposes that may be the same as or different from other processors 120 of the processing device 110 or the SoC 115. One or more of the processors 120 and processor cores of the same or different configurations may be grouped together. A group of processors 120 or processor cores may be referred to as a multi-processor cluster.

The processing device 110 may further include one or more sensor(s) 136, such as an altimeter or camera, which may be used by the processor 120 to determine flight attitude and location information to control various processes on the robotic vehicle 100. For example, in some embodiments, the processor 120 may use data from sensors 136 (e.g., a light sensor using photo-resistors, photodiodes, and/or phototransistors) as an input for the robotic vehicle 100. As a further example, the one or more sensor(s) 136 may include a camera unit, which may be used for a variety of applications. For example, the camera unit may be used to facilitate navigation, such as enabling the robotic vehicle 100 to follow or navigate toward an identified feature such as a road intersection. The camera unit may be used for other purposes such as location identification, guiding the robotic vehicle to land at a drop-off position at a delivery destination, photographing or identifying the recipient of the package or credentials presented by the recipient, and so on. One or more other input units 126 may also be coupled to the processor 120. Various components within the processing device 110 and/or the SoC 115 may be coupled together by various circuits, such as a bus 125, 135 or another similar circuitry.

In various embodiments, the processing device 110 may include or be coupled to one or more communication component 132, such as a wireless transceiver, an onboard antenna, and/or the like for transmitting and receiving wireless signals through one or more wireless communication link 325. The one or more communication component 132 may be coupled to the communication interface 124 and may be configured to handle wireless wide area network (WWAN) communication signals (e.g., cellular data networks) and/or wireless local area network (WLAN) communication signals (e.g., Wi-Fi signals, Bluetooth signals, etc.) associated with ground-based transmitters/receivers (e.g., base stations, beacons, Wi-Fi access points, Bluetooth beacons, small cells (picocells, femtocells, etc.), etc.). The one or more communication component 132 may receive data from radio nodes, such as navigation beacons (e.g., very high frequency (VHF) omni-directional range (VOR) beacons), Wi-Fi access points, cellular network base stations, radio stations, etc.

The processing device 110, using the processor 120, the one or more communication component 132, and an antenna 131 may be configured to conduct wireless communications with a variety of wireless communication devices, examples of which include the base station or cell tower (e.g., base station 310), a beacon, server, a smartphone, a tablet, or another computing device with which the robotic vehicle 100 may communicate. The processor 120 may establish the wireless communication link 325 via the communication components 132 and the antenna 131. In some embodiments, the one or more communication component 132 may be configured to support multiple connections with different wireless communication devices using different radio access technologies. In some embodiments, the one or more communication component 132 and the processor 120 may communicate over a secured communication link. The security communication links may use encryption or another secure means of communication to secure the communication between the one or more communication component 132 and the processor 120.

The wireless communication link 325 may allow an operator or remote controller to communicate (e.g., providing navigational commands or exchanging other data) with the robotic vehicle 100 via the base station 310. The wireless communication link 325 may include a plurality of carrier signals, frequencies, or frequency bands, each of which may include a plurality of logical channels. The wireless communication link 325 may utilize one or more radio access technologies (RATs). Examples of RATs that may be used in the wireless communication link 325 include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the mission environment include medium range protocols such as Wi-Fi, LTE-U, LTE-Direct, LAA, MuLTEfire, and relatively short-range RATs such as ZigBee, Bluetooth, and Bluetooth Low Energy (LE).

While the various components of the processing device 110 are illustrated as separate components, some or all of the components (e.g., the processor 120, the memory 121, and other units) may be integrated together in a single device or module, such as a system-on-chip module (e.g., the SoC 115).

Robotic vehicles may navigate or determine positioning using altimeters or navigation systems, such as Global Navigation Satellite System (GNSS), Global Positioning System (GPS), etc. In some embodiments, the robotic vehicle 100 may use an alternate source of positioning signals (i.e., other than GNSS, GPS, etc.). The robotic vehicle 100 may use position information associated with the source of the alternate signals together with additional information (e.g., dead reckoning in combination with last trusted GNSS/GPS location, dead reckoning in combination with a position of the robotic vehicle takeoff zone, etc.) for positioning and navigation in some applications. Thus, the robotic vehicle 100 may navigate using a combination of navigation techniques, including dead-reckoning, camera-based recognition of the land features below and around the robotic vehicle 100 (e.g., recognizing a road, landmarks, highway signage, etc.), etc. that may be used instead of or in combination with GNSS/GPS location determination and triangulation or trilateration based on known locations of detected wireless access points.

In some embodiments, the processing device 110 of the robotic vehicle 100 may use one or more of various input units 126 for receiving control instructions, data from human operators or automated/pre-programmed controls, and/or for collecting data indicating various conditions relevant to the robotic vehicle 100. For example, the input units 126 may receive input from one or more of various components, such as camera(s), microphone(s), position information functionalities (e.g., a global positioning system (GPS) receiver for receiving GPS coordinates), flight instruments (e.g., attitude indicator(s), gyroscope(s), anemometer, accelerometer(s), altimeter(s), compass(es), etc.), keypad(s), etc. The camera(s) may be optimized for daytime and/or nighttime operation.

Various embodiments may be implemented within a variety of communication networks, such as private networks between computing devices, public networks between computing devices, or combinations of private and public networks, as well as cellular data networks and satellite communication networks. A robotic vehicle may travel over varying distances over varying terrain including roadways. Therefore, robotic vehicle may require communications to be maintained while the robotic vehicle is travelling toward a destination in either a docked, landed, and/or flying state.

Various embodiments may be implemented with alternative robotic vehicles, configured to transport and deliver one or more items for delivery, another example of which is illustrated in FIG. 4. With reference to FIGS. 1-4, the robotic vehicle 400 may be a terrestrial-based vehicle including wheels 401, a motor, and a frame 403 for supporting a full weight of the robotic vehicle 400 and any cargo. In various embodiments, the robotic vehicle 400 may be configured to secure the item 50 with the security device 200 to the robotic vehicle 400. Parts of the frame 403 may include elements like a trailer or containment area 450 and payload securing unit 470 that secures the security device 200, holding the item 50 therein, to the robotic vehicle 100. The containment area 450 and the payload securing unit 470 may hold more than one security device 200.

The payload securing unit 470 may include (but is not limited to) a gripping and release mechanism (e.g., 170 in FIGS. 2A and 2B) or other suitable mechanism, a conveyor, and so on, that may be rated sufficiently to grasp and hold one or more security device 200-206. The payload securing unit 470 may include a motor that drives the gripping and release mechanism, the conveyor, and other controls, which may be responsive to selectively grip and release individual security devices. The robotic vehicle 400 is illustrated (e.g., FIG. 4) as having a plurality of security devices 201-206, in the containment area 450, held by the payload securing unit 470. Each of the plurality of security devices 201-206 may include separate items, for delivery, therein. In addition, as illustrated, one security device 200 has been released from the containment area 450 and dropped-off at a delivery destination with the item 50 still secured inside the security device 200. The conveyor may selectively move an appropriate one of the plurality of security devices 201-206 to a release area (e.g., the back end of the containment area), before releasing that security device with the item contained therein. The conveyor may have a carousel-style configuration so the plurality of security devices 201-206 do not have to be delivered in a reverse order to that loaded into the containment area 450.

The robotic vehicle 400 may be configured with processing and communication devices that enable the robotic vehicle 400 to navigate, such as by controlling the motors and steering to drive the robotic vehicle 400 to one or more destinations and position the vehicle appropriately once at a destination. For ease of description and illustration, some details of the robotic vehicle 400 are omitted such as wiring, frame structure interconnects or other features that would be known to one of skill in the art.

Various embodiments may be implemented with a variety of security devices, which may vary to suit the particular item to be delivered and/or the overall system of delivery. For example, the security devices may range from something small, like the security tags used for selling retail clothing and other merchandise, to something larger, like a transport container. Not all items for delivery are suited to easily having a security tag attached thereto, thus a transport container may be more suitable for such items. Also, a transport container is handy for transporting multiple smaller items together as a unit. Alternatively, not all items may fit inside a transport container of a set size, thus a security tag may be more versatile. In addition, security devices may range in the number of features included. For example, a security device may range from having only a key-lock mechanism to having a plurality of security features, such as a processor, communication device, tamper detection/prevention, a user interface, an alarm, etc. Thus, the type of security device and features included therewith may be selected as desired.

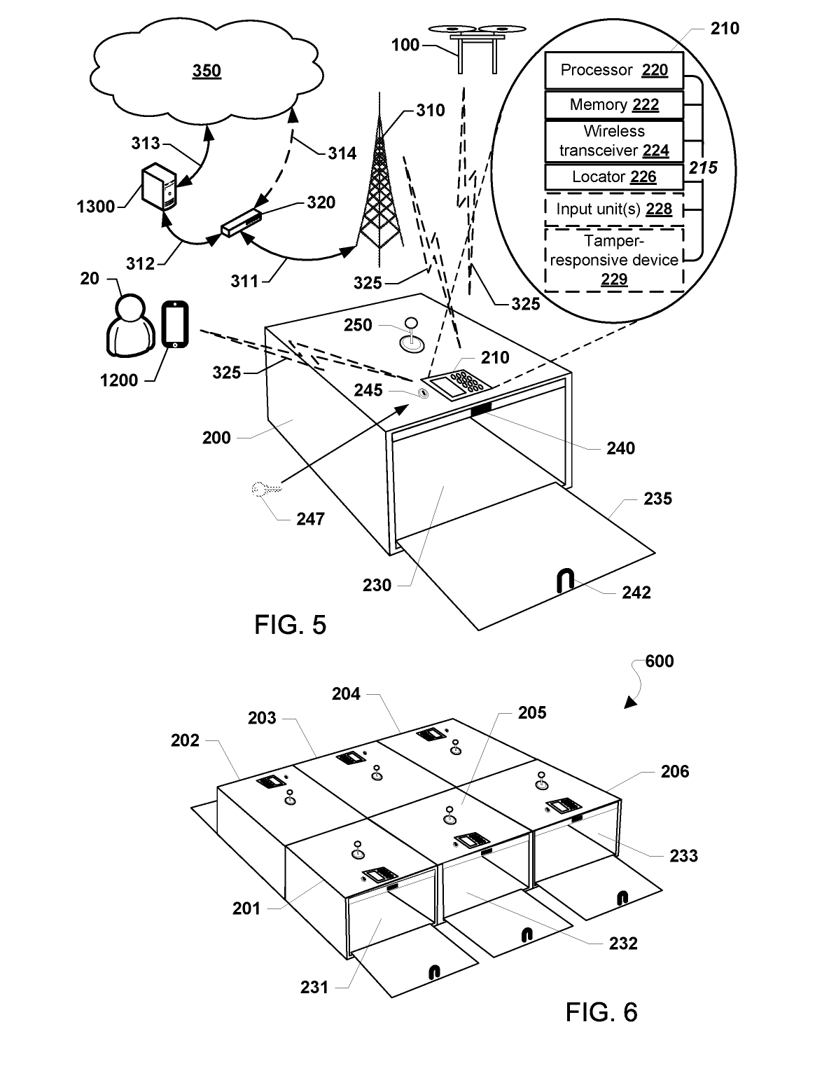

Various embodiments may be implemented with security devices formed as a transport container to enclose the one or more items for delivery, an example of which is illustrated in FIG. 5. With reference to FIGS. 1-5, the security device 200 is configured to hold and secure an item (e.g., 50) therein. The security device 200 includes an inner chamber 230, a lockable panel 235 that is locked or unlocked by a latch 240 that receives a latch hook 242. The authenticating mechanism that locks and/or unlocks the latch 240 may work in conjunction with a processing device 210 of the security device 200 in conjunction with a user interface (e.g., buttons and/or display, which may be a touch-screen display) or other input received by an input unit 228. Thus, rather than a physical key, the authenticating mechanism may be a password/access-code, finger-print scan, or other security measure. Alternatively or as a redundancy, the latch 240 may be controlled by a key-lock mechanism 245 that works with a physical key 247. In some embodiments, the security device 200 may use wireless communications to open the latch 240 and thus release the item (e.g., 50) for delivery. For example, the security device 200 may use near-field communication (NFC) devices (e.g., RFID initiator/target pair). In this way, the recipient may use an RFID fob or other NFC device to open the latch.

The authenticating mechanisms (e.g., the physical device and/or security data) may be provided to the recipient separately. For example, the password/access-code, access card, key fob, the physical key 247, and/or instructions for implementing the authentication mechanism may have been transmitted, mailed or shipped in advance to the automated recovery system or recipient or the recipient may have picked-up the authenticating mechanism at a designated location. The password/access-code, other security data, and/or instructions may also be electronically delivered in advance. As a further alternative, specifications for 3D printing of the physical key 247 may be provided to the recipient ahead of time so the recipient may generate a physical key. A 3D printed key may be intentionally weak or prone to breakage to provide only limited or even one-time use. This may limit the number of times a recipient may use the security device 200 or the number of times the recipient may attempt to open the security device 200.

Alternatively, the security device 200 may use the wireless communication link 325 that provide long-range wireless communications to receive instructions to open the latch 240 and thus release the item. For example, a recipient may interact with the security device 200 through a security application (referred to herein as a “security app”) on the mobile computing device 1200, a website accessed using the mobile computing device 1200, or the like. In some embodiments, one or both of the mobile computing device 1200 and the security device 200 may be executing the security app to facilitate communication with the security device 200 and/or the robotic vehicle 100. The security app may communicate with the security device 200 (and optionally the robotic vehicle and/or the server 1000) to facilitate carrying out functions such as release of the item after delivery. The security app may generate the password/access-code for the user to enter a user interface of the security device 200. In further embodiments, the password/access-code may expire after a brief period (e.g., 60 seconds). Alternatively and/or additionally, the security app may use multi-factor authentication (e.g., 2-factor authentication) that requires not only a password and/or user name, but also something that only the authorized recipient should have or have access to. The security app may work in conjunction with existing security protocols available on a mobile computing device (e.g., Touch ID or other security features). The security app may perform additional functions such as reporting whether the item was delivered without damage, how satisfied the recipient is with the delivery, and other operations.

Optionally, the security device 200 may include a protruding coupling element 250 configured to be received by the payload securing unit (e.g., 170) of the robotic vehicle (e.g., 100, 400).

The material(s) used to form the security device 200, particularly the walls forming the inner chamber 230, may depend on the level of security desired. For example, for a low-security version of the security device 200, the walls may be formed of plastic, metal sheeting, wood, etc. Higher-security versions of the security device 200 may have walls made of tamper-resistant materials, such as aramid or para-aramid synthetic fiber (e.g., Kevlar®), graphite, metals, etc. Also, the security device 200 may include components for protecting the item or items to be delivered, such as refrigeration, insulation or dry ice for maintaining the item (e.g., good or medicine) cold or at a controlled temperature, a supply of a gas or gas mixture (e.g., nitrogen or argon) for maintaining a certain atmosphere around the item, a pressure vessel to maintain constant air pressure around the item, etc.

The security device processing device 210 may be configured to monitor and control the various functionalities, subsystems, and/or other components of the security device 200. For example, the security device processing device 210 may be configured to monitor and control various functionalities of the security device 200, such as any combination of modules, software, instructions, circuitry, hardware, etc. related to propulsion, navigation, power management, sensor management, and/or stability management.

The security device processing device 210 may include various circuits and devices used to control the operation of the security device 200. For example, the security device processing device 210 may include a processor 220 that directs the control systems of the security device 200. The processor 220 may include one or more processors configured to execute processor-executable instructions (e.g., applications, routines, scripts, instruction sets, etc.) to control the latch 240, antenna usage, and other operations of the security device 200, including operations of various embodiments. In some embodiments, the security device processing device 210 may include memory 222 coupled to the processor 220 and configured to store data (e.g., authenticating mechanism specifications, obtained sensor data, received messages, applications, etc.).

The security device processing device 210 may further include a locator 226, such as GPS and/or motion/proximity sensors, that may be used by the processor 220 to determine location and/or movement and to control various processes on the security device 200. For example, in some embodiments, the processor 220 may use data from the locator 226 (e.g., movement of the security device 200 more than a predetermined distance from a drop-off position at a delivery destination with the item secured thereto) as an input for determining whether to activate an alert device (e.g., an alarm or beacon). Input unit(s) 228 may receive input from sensors or a user interface, which may also be coupled to the processor 220. Various components within the security device processing device 210 may be coupled together by various circuits, such as a bus 215.

In various embodiments, the security device processing device 210 may include or be coupled to communication resources, such as a wireless transceiver 224 and an onboard antenna for transmitting and receiving wireless signals through the wireless communication link 325. The wireless transceiver 224 may be configured to handle wireless wide area network (WWAN) communication signals (e.g., cellular data networks) and/or wireless local area network (WLAN) communication signals (e.g., Wi-Fi signals, Bluetooth signals, etc.) associated with ground-based transmitters/receivers (e.g., base stations, beacons, Wi-Fi access points, Bluetooth beacons, small cells (picocells, femtocells, etc.), etc.). The wireless transceiver 224 may receive data from radio nodes, such as navigation beacons (e.g., very high frequency (VHF) omni-directional range (VOR) beacons), Wi-Fi access points, cellular network base stations, radio stations, etc.

The security device processing device 210, using the processor 220, the wireless transceiver 224, and an antenna may be configured to conduct wireless communications with a variety of wireless communication devices, examples of which include the mobile computing device 1200 (operated by a recipient 20 or other individual), the robotic vehicle 100, base stations or cell towers (e.g., base station 310), a beacon, server, a smartphone, a tablet, or another computing device with which the security device 200 may communicate. The processor 220 may establish the wireless communication link 325, which may be bi-directional, via a modem and an antenna. In some embodiments, the wireless transceiver 224 may be configured to support multiple connections with different wireless communication devices using different radio access technologies. In some embodiments, the wireless transceiver 224 and the processor 220 may communicate over a secured communication link. The security communication links may use encryption or another secure means of communication to secure the communication between the wireless transceiver 224 and the processor 220.

The security device 200 may include a tamper-responsive device 229 that may initiate an alert or disable, damage, destroy, or otherwise render unusable the item (e.g., 50) upon detection of tampering or that the security device 200 has been moved more than a predetermined distance (e.g., 10-100 yards or meters) from a drop-off position at the delivery destination. Tampering may include damage to the security device 200 or one or more invalid authenticating mechanisms being used to attempt to release the item. In response to a sensor (e.g., input units 228) detecting or the processor 220 determining that the security has been tampered with or moved more than the predetermined distance from the drop-off position of the security device, the tamper-responsive device 229 may be activated. For example, the security device 200 may include a tamper-responsive device 229 that may damage, disable, or otherwise render unusable (permanently or until the proper authorization is received) the item, by short-circuiting electronics of the item, exploding an ink bomb or liquid that will damage (e.g., stain) the item, using a needle-plunger inside the casing 930 (FIG. 9) that is configured to pierce both the casing 930 and the packaging of the item and inject ink, apply an electric charge, or accomplish another destruction mechanism.

Additionally or alternatively, the security device 200 may include an alarm device that activates an alert (e.g., sounds an alarm, turns on an indicator/beacon, transmits a message, or provides some other indication) in response to the detection of tampering or excessive movement beyond the predetermined distance or geofenced area. In this way, the tamper-responsive device 229 may provide a way of indicating the security device 200 has been tampered with or moved more than a predetermined distance from a drop-off position at the delivery destination.

In some embodiments, in response to the item not being claimed after a predetermined period, the tamper-responsive device 229 may be used to notify the sender that the security device with the item still attached thereto needs to be reclaimed. The predetermined period may be a default amount of time, may be set by the entity transporting the item via the robotic vehicle, may be set by the intended recipient of the item (e.g., a purchaser or requester of the item or a party authorized by the purchaser/requester), may be based on the type of item being transported by the robotic vehicle (e.g., a relatively short predetermined period may be implemented if the item contains sensitive information as compared to a typical item that doesn't contain sensitive information), and/or the like. In some embodiments, the tamper-responsive device 229 may be configured to disable, damage, and/or destroy the item upon expiration of the predetermined period.

While the various components of the security device processing device 210 are illustrated as separate components, some or all of the components (e.g., the processor 220, the memory 222, and other units) may be integrated together in a single device or module, such as a system-on-chip module.

A remote computing device 320 may be configured to control the robotic vehicle 100, the security device 200, and/or control wireless communications over a wide area network, such as providing a wireless access points and/or other similar network access point using the base station 310. In addition, the remote computing device 320 and/or the communication network 350 may provide access to a server 1300. The security device 200 may be configured to communicate with the remote computing device 320 and/or the server 1300 for exchanging various types of communications and data, including location information, pass-key verifications, alerts, data inquiries, delivery confirmations, pick-up instructions, etc.

FIG. 6 illustrates another example of a security device for securing one or more items for delivery. With reference to FIGS. 1-6, the security device 600 (which may generally be similar to the security device 200) may include multiple compartments 231, 232, 233 each with separate lockable panel with a different authentication requirement. Thus, for example, the robotic vehicle (e.g., robotic vehicles 100, 400) may deliver orders for several different customers to a general area. Each customer may go to the delivered security device 600 and separately authenticate their respective delivery to open their respective compartment for their item. The security device 600 may be formed as a single structure with multiple compartments or a plurality of joined substructures, like a plurality of individual security devices 201, 202, 203, 204, 205, 206.

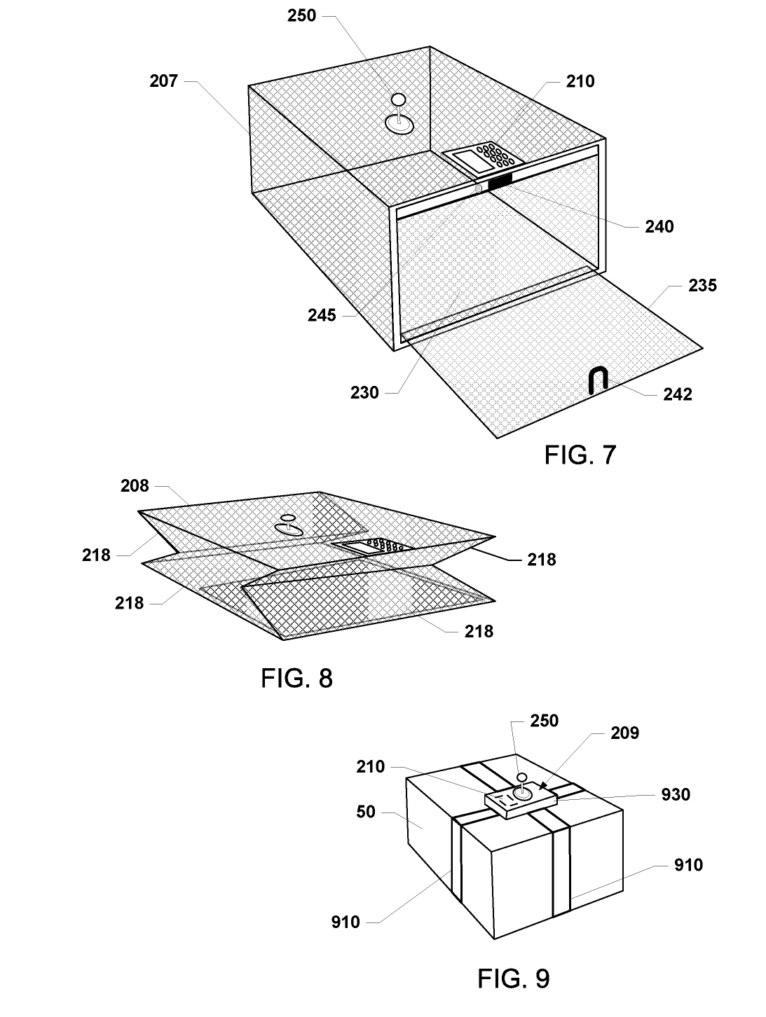

Various embodiments include a security device 207 with open walls, an example of which is illustrated in FIG. 7. With reference to FIGS. 1-7, the security device 207 (which may generally be similar to the security device 200, 600) is formed as a cage, with a mesh webbing, bars, or wires forming the outer walls defining the inner chamber 230.

In some embodiments, the security device (200, 600, 207) may be configured to be collapsible foldable structures for reducing a size of the security device after removal of the item (i.e., after delivery), an example of which 208 is illustrated in FIG. 8. With reference to FIGS. 1-8, the security device 208 may include one or more walls 218 that collapse and/or fold for reducing an overall size of the security device 208. Once made smaller, the security device 208 may be more easily returned to the entity that sent the item, dropped off at a return center, or transported generally.

In some embodiments, the security devices (e.g., 200, 207, 208, 600) may be designed to be returned to the sender or other party. For example, the security device may be (but is not limited to) picked up in a future robotic vehicle delivery, mailed back or returned with a return item, dropped off at a collection kiosk, retrieved by an operator agent (e.g., UPS/FedEx), or picked up by a robotic vehicle (e.g., 100, 400). The pick-up by a robotic vehicle may occur automatically after a predetermined period without the item inside being claimed or automatically after the security device reports (via wireless communications) that the item inside has been properly removed. In other embodiments, the pick-up may occur in response to some trigger event, such as (but not limited to) a request by the delivery recipient, a request by the sender, etc.

In some embodiments, security devices may be configured to be attached to an outside of (or otherwise on or along) one or more items for delivery, an example of which is illustrated in FIG. 9. With reference to FIGS. 1-9, the security device 209 may be a security tag that includes a casing 930 that may hold security features, like tamper detection sensors, processing device 210, cables or straps 910, a protruding coupling element 250, and the like.

The security device 209 may be configured to release the item 50 upon presentation of an authenticating mechanism. A mechanism inside the casing 930 may release one or more of the straps 910. Like the security device 200, the authenticating mechanism of the security device 209 may be a physical key, key card, token, proximity-based key/token, signature, finger print, face/gesture recognition, retinal scan, pass-code, and/or authentication information communicated through signaling. Release of the straps 910 may be controlled from a key-lock mechanism that receives and verifies the authenticating mechanism for locking or unlocking the straps 910. Alternatively or additionally, the straps 910 may be unlocked using a processing device 210 that provides a user interface (e.g., buttons and/or display, which may be a touch-screen display). Thus, rather than a physical key, the processing device 210 may be used to enter/receive a password/access-code, biometric identification, or other authenticating mechanism.

In some embodiments, the security device 209 may use wireless communications to release the straps 910 and thus release the item (e.g., 50) for delivery. For example, the security device 209 may receive release authorization via an NFC device, such as RFID initiator/target pairing. In this way, the recipient may use an RFID fob or other NFC device to open the straps 910 of the security device 209. Alternatively, the security device 200 may use a wireless communication link (e.g., 325) that provides long-range wireless communications to receive instructions to release the straps 910 thereby enabling remote release of the item. For example, a recipient may interact with the security device 209 through a customized application on a mobile computing device (e.g., 1200), a website accessed using the mobile computing device, or the like.

Optionally, the security device 209 may include a protruding coupling element 250 that is configured to be received by the payload securing unit (e.g., 170) of the robotic vehicle (e.g., 100, 400).

The security device 209 may also be a tamper-responsive device (e.g., tamper-responsive device 229 in FIG. 5) that may initiate an alert or disable, damage, destroy, or otherwise render unusable the item (permanently or until the proper authorization is received) (e.g., 50) upon detection of tampering or that the security device 209 has been moved more than a predetermined distance from a drop-off position at the delivery destination or beyond a geofenced area.

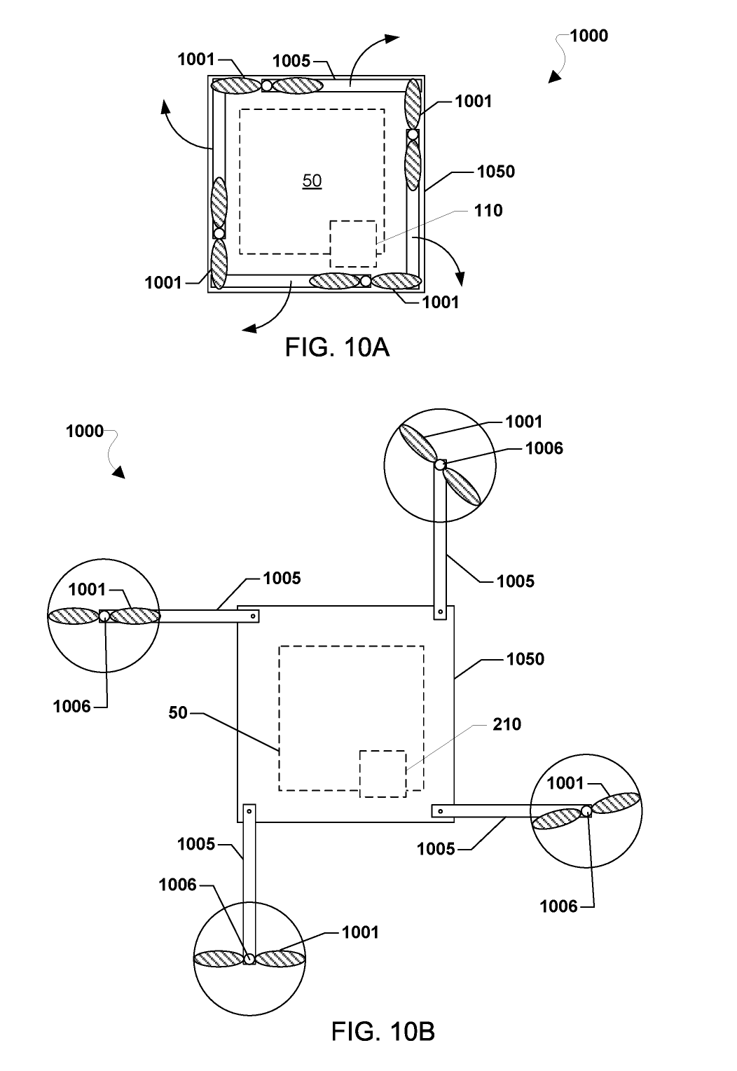

Various embodiments may be implemented with a security device that includes its own propulsion sub-system for transporting itself away from the delivery destination, an example of which 1000 is illustrated in FIGS. 10A and 10B. With reference to FIGS. 1-10B, the security device 1000 may be configured as a mini-folding robotic vehicle that can transport itself back to home base or a safe location. A base structure 1050 of the security device 1000 may be similar to other security devices described herein (e.g., 200-209 and 600), which may include the processing device 210 and an inner chamber for holding the item 50.

In some embodiments, the security device 1000 may include retractable or deployable arms 1005 that support rotors 1001 and flight motors 1006. The retractable/deployable arms 1005 are illustrated in a stowed position in FIG. 10A, in which the retractable/deployable arms 1005 are pivoted toward the base structure 1050. From the stowed position, the retractable/deployable arms 1005 may pivot outwardly to a deployed position (e.g., as illustrated in FIG. 10B). In the deployed position, the retractable/deployable arms 1005 extend away from the base structure 1050 to allow the rotors 1001 to spin freely. The security device 1000 may be configured to automatically change from the stowed position to the deployed position in response to the item 50 being removed or after a set amount of time after the delivery of the item at the delivery destination. Alternatively, the security device 1000 may change from the stowed position to the deployed position in response to receipt of instructions to do so from the recipient or a remote computing device.

In some embodiments, rather than providing a propulsion sub-system that automatically unfolds or deploys, the recipient (e.g., 20) may have to perform partial assembly for the security device 1000 to look and function like a mini-robotic vehicle before sending it on its way. In some embodiments, the recipient may return the base structure 1050 to a designated facility (e.g., a return center) and the propulsion sub-system may be added there, before the security device 1000 is sent back to base.

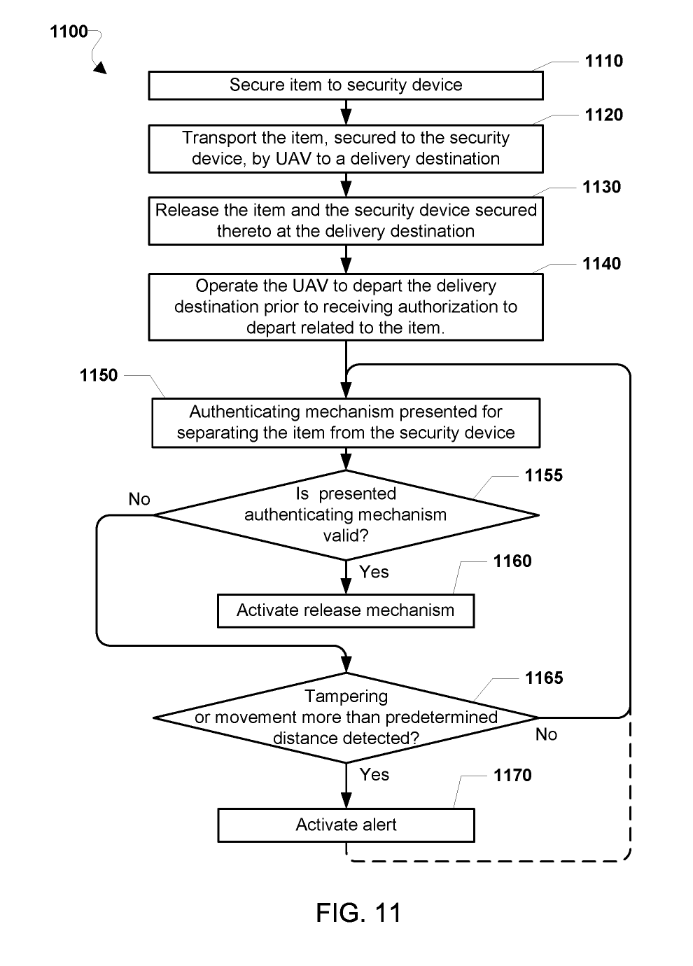

FIG. 11 illustrates a method 1100 of delivering an item (e.g., 50) via a robotic vehicle (e.g., 100) with a security device (200-209, 600) according to various embodiments. With reference to FIG. 1-11, operations of the method 1100 may be performed by a processing device (e.g., 110, 210) of the robotic vehicle, the security device or other computing device (e.g., mobile computing device 1200 or server 1300). To perform the operations of the embodiment method 1100, the robotic vehicle and/or the security device may communicate with the mobile computing device 1200 and/or the server 1300 to securely deliver at item to a recipient.

In block 1110, the item may be secured to the security device 200. For instance, an individual or an automated system controlled by the sender of the item may secure the item 50 to the security device 200. For security devices that include an inner compartment, securing the item 50 to the security device 200 may include positioning or inserting the item 50 in that inner compartment, as well as making sure the item 50 is stable and secure. In addition, any compartment panels or straps should be closed or secured. Alternative security devices that do not include an inner compartment may be secured to the outside of the item 50.

In block 1120, a processor (e.g., 110) of the robotic vehicle (e.g., 100, 400) may control the robotic vehicle to transport the item secured to the security device to a delivery destination. The robotic vehicle may carry the item attached to a payload securing unit. The robotic vehicle may include a cargo hold and/or a containment area for holding the security device secured to the item.

In block 1130, the processor of the robotic vehicle may release the item and the security device secured thereto at the delivery destination. The release of the security device (and the item secured by the security device) occurs prior to receiving authorization to release the security device (and the item). The processor may receive location information from a GPS navigation unit and/or receive a message over a wireless communication line from a remote computing device, which may indicate and/or confirm the robotic vehicle has arrived at the delivery destination.

In block 1140, the processor of the robotic vehicle may direct the robotic vehicle to depart from the delivery destination. The departure by the robotic vehicle from the delivery destination without the item occurs prior to receiving authorization to depart relating to the item. In this way, when departing from the delivery destination the robotic vehicle leaves the item secured to the security device at the delivery destination.

In block 1150, the processor of the security device may receive an indication that an authenticating mechanism is being presented for separating the item from the security device. The presented key may be a physical key (e.g., a key 247 that is appropriately shaped to fit inside a mechanical lock 245 or a key fob using RFID or other NFC device) or a virtual key received via the wireless communication link.

In determination block 1155, the processor of the security device may determine whether the presented authenticating mechanism is valid for removing the security device from the item. The determination whether the presented authenticating mechanism is valid may occur after the robotic vehicle has departed from the delivery destination.

In response to determining that the presented authenticating mechanism is valid (i.e., determination block 1155=“Yes”), the processor may activate a release mechanism (e.g., latch 240) in block 1160, which allows the item to be separated (i.e., released) from the security device.

In response to determining that the presented authenticating mechanism is not valid (i.e., determination block 1155=“No”), the processor may determine whether tampering or movement more than a predetermined distance from the drop-off position at the delivery destination is detected in determination block 1165.

In some embodiments, the security device may include a locator, an alert device, and a security device processor for determining whether movement more than the predetermined distance from the drop-off position at the delivery destination has occurred. The predetermined distance may act like a boundary or geo-fence selected to allow some movement of the security device, but limit movement to avoid tampering or theft of the security device and the item therein. The boundary or geo-fence may be a circular perimeter centered at the drop-off position or a non-circular boundary as desired. The locator may be configured to gather location information of the security device. In particular, the locator device may be configured to detect movement after the robotic vehicle has departed from the delivery destination without the item and/or the security device. The alert device may indicate that the security device has been moved more than the predetermined distance from the drop-off position at the delivery destination. The security device processor may be coupled to the locator and the alert device. Thus, the security device processor may be configured with processor-executable instructions to receive location information gathered by the locator and determine, based on the received location information, whether the security device has moved more than a predetermined distance from the drop-off position at the delivery destination.

In response to determining that tampering or movement more than the predetermined distance from the drop-off position is detected (i.e., determination block 1165=“Yes), the processor may activate an alert in block 1170. Optionally, following the activation of the alert, the processor of the security device may wait to receive another indication that an authenticating mechanism is being presented for separating the item from the security device in block 1150.

In response to determining that tampering or movement more than the predetermined distance from the drop-off position has not been detected (i.e., determination block 1165=“No”), the processor of the security device may continue to wait for an indication that an authenticating mechanism is being presented for separating the item from the security device in block 1150.

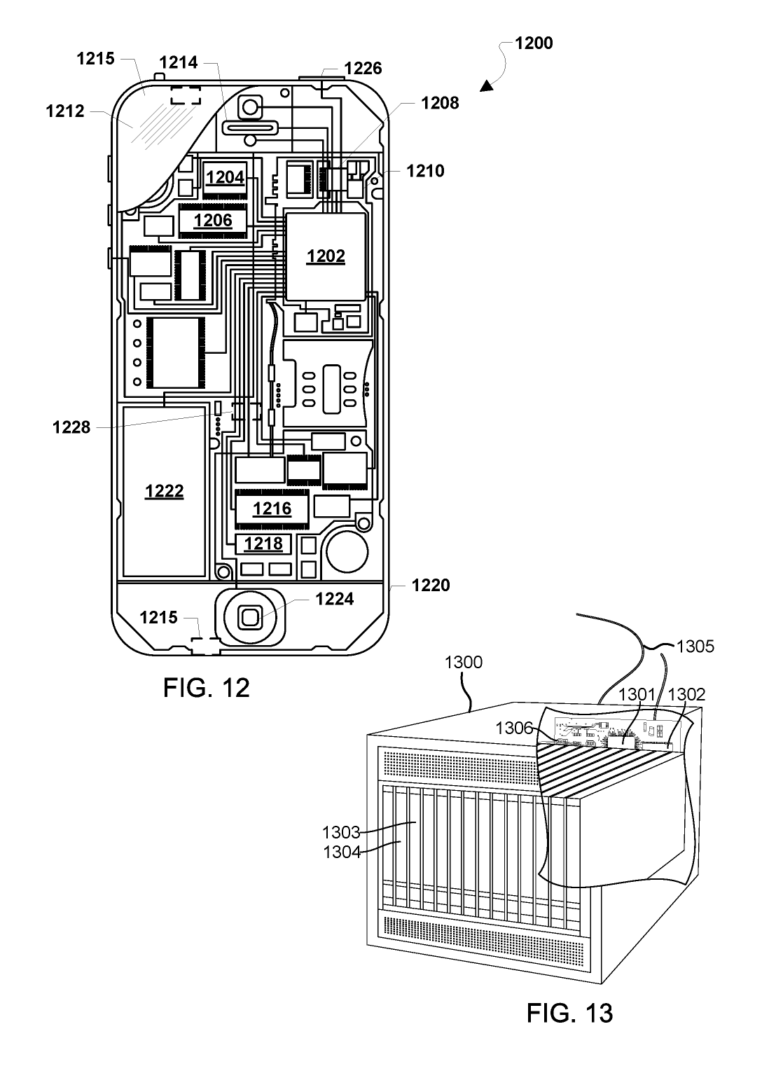

In some embodiments involving communications with the robotic vehicle 100 or the security device 200 through a security application (or ‘app’), the security system may interact with any of a variety of mobile computing devices (e.g., smartphones, tablets, smartwatches, etc.) an example of which is illustrated in FIG. 12. The mobile computing device 1200 may include a processor 1202 coupled with the various systems of the mobile computing device 1200 for communication with and control thereof. For example, the processor 1202 may be coupled to a touch screen controller 1204, radio communication elements, speakers and microphones, and an internal memory 1206. The processor 1202 may be one or more multi-core integrated circuits designated for general or specific processing tasks. The internal memory 1206 may be volatile or non-volatile memory, and may also be secure and/or encrypted memory, or unsecure and/or unencrypted memory, or any combination thereof. In another embodiment (not shown), the mobile computing device 1200 may also be coupled to an external memory, such as an external hard drive.

The touch screen controller 1204 and the processor 1202 may also be coupled to a touch screen panel 1212, such as a resistive-sensing touch screen, capacitive-sensing touch screen, infrared sensing touch screen, etc. Additionally, the display of the mobile computing device 1200 need not have touch screen capability. The mobile computing device 1200 may have one or more radio signal transceivers 1208 (e.g., Peanut, Bluetooth, Bluetooth LE, ZigBee, Wi-Fi®, radio frequency (RF) radio, etc.) and antennae, the mobile computing device antenna 1210, for sending and receiving communications, coupled to each other and/or to the processor 1202. The radio signal transceivers 1208 and the mobile computing device antenna 1210 may be used with the above-mentioned circuitry to implement the various wireless transmission protocol stacks and interfaces. The mobile computing device 1200 may include a cellular network wireless modem chip 1216 coupled to the processor that enables communication via a cellular network.

The mobile computing device 1200 may include a peripheral device connection interface 1218 coupled to the processor 1202. The peripheral device connection interface 1218 may be singularly configured to accept one type of connection, or may be configured to accept various types of physical and communication connections, common or proprietary, such as USB, FireWire, Thunderbolt, or PCIe. The peripheral device connection interface 1218 may also be coupled to a similarly configured peripheral device connection port (not shown).

In various embodiments, the mobile computing device 1200 may include microphones 1215. For example, the mobile computing device may have a microphone 1215 for receiving voice or other audio frequency energy from a user during a call.

The mobile computing device 1200 may also include speakers 1214 for providing audio outputs. The mobile computing device 1200 may also include a housing 1220, constructed of a plastic, metal, or a combination of materials, for containing all or some of the components discussed herein. The mobile computing device 1200 may include a power source 1222 coupled to the processor 1202, such as a disposable or rechargeable battery. The rechargeable battery may also be coupled to the peripheral device connection port to receive a charging current from a source external to the mobile computing device 1200. The mobile computing device 1200 may also include a physical button 1224 for receiving user inputs. The mobile computing device 1200 may also include a power button 1226 for turning the mobile computing device 1200 on and off.

In some embodiments, the mobile computing device 1200 may further include an accelerometer 1228, which senses movement, vibration, and other aspects of the device through the ability to detect multi-directional values of and changes in acceleration. In the various embodiments, the accelerometer 1228 may be used to determine the x, y, and z positions of the mobile computing device 1200. Using the information from the accelerometer, a pointing direction of the mobile computing device 1200 may be detected.

Various forms of computing devices may be used to communicate with a processor of a robotic vehicle, including personal computers, mobile computing devices (e.g., smartphones, etc.), servers, laptop computers, etc., to implement the various embodiments including the embodiments described with reference to FIGS. 1-13. Such computing devices may typically include, at least, the components illustrated in FIG. 13, which illustrates an example server computing device. With reference to FIGS. 1-13, the server 1300 may typically include a processor 1301 coupled to volatile memory 1302 and large capacity nonvolatile memory 1303, 1304, such as a disk drive. The server 1300 may also include one or more disc drives (e.g., compact disc (CD) or digital versatile disc (DVD)) coupled to the processor 1301. The server 1300 may also include network access ports 1305 (or interfaces) coupled to the processor 1301 for establishing data connections with a network, such as the Internet and/or a local area network coupled to other system computers and servers. Similarly, the server 1300 may include additional access ports 1306, such as USB, Firewire, Thunderbolt, and the like for coupling to peripherals, external memory, or other devices.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A delivery system for delivering an item, comprising:
a security device configured to secure the item, wherein the security device is removable from the item using an authenticating mechanism and configured to render the item unusable without authorized removal or deactivation of the security device; and
a robotic vehicle, comprising:
a payload securing unit configured to selectively hold the item or the security device while the item is secured with the security device;
a robotic vehicle propulsion system configured to move the robotic vehicle from one location to a delivery destination; and
a robotic vehicle processor coupled to the payload securing unit and the robotic vehicle propulsion system, wherein the robotic vehicle processor is configured with processor-executable instructions to:
transport the item to the delivery destination while held by the payload securing unit and secured with the security device; and
depart the delivery destination prior to receiving authorization to depart relating to the item.

2. The delivery system of claim 1, wherein the security device is a transport container enclosing the item therein.

3. The delivery system of claim 2, wherein the transport container includes a lockable panel configured to open using the authenticating mechanism.

4. The delivery system of claim 2, wherein the transport container encloses the item in a compartment therein.

5. The delivery system of claim 2,
wherein the transport container includes a plurality of separate compartments, and
wherein at least one of the separate compartments is configured to hold the item and at least one other of the separate compartments is configured to hold a different item for delivery.

6. The delivery system of claim 5,
wherein the authenticating mechanism includes a first authenticating mechanism and a second authenticating mechanism, and
wherein the first authenticating mechanism opens one of the separate compartments and the second authenticating mechanism opens another of the separate compartments.

7. The delivery system of claim 1, further comprising:
another security device secured to at least one other item for delivery,
wherein the payload securing unit is configured to selectively hold the at least one other item while the at least one other item is secured to the other security device, and
wherein a release mechanism is configured to selectively release at least one of the item and the other item.

8. The delivery system of claim 1, wherein the security device further comprises at least one of:
a user interface coupled to a security device processor, wherein the user interface is configured to receive security data in the form of at least one of a signature, biometric identification, gesture, password, and access-code, wherein the security device processor is configured with processor-executable instructions to determine whether the received security data matches a predetermined code designated as the authenticating mechanism for removing the security device from the item; and
a key-lock mechanism for receiving a physical key used as the authenticating mechanism for removing the security device from the item.

9. The delivery system of claim 1, wherein the security device further comprises:
a locator configured to gather location information of the security device;
an alert device for indicating the security device has been moved more than a predetermined distance from a drop-off position at the delivery destination; and
a security device processor coupled to the locator and the alert device,
wherein the security device processor is configured with processor-executable instructions to:
receive location information gathered by the locator;
determine, based on the received location information, whether the security device has moved more than the predetermined distance from the drop-off position of the security device, wherein movement is detected by the locator after the robotic vehicle has departed from the delivery destination without the security device; and
activate an alert in response to determining that the security device has moved more than the predetermined distance from the drop-off position.

10. The delivery system of claim 9, wherein activating the alert is further in response to the security device processor:
determining that the item is still secured to the security device; and
determining that the security device has not been unlocked since the robotic vehicle arrived at the delivery destination.

11. The delivery system of claim 1, wherein the robotic vehicle departing the delivery destination prior to receiving authorization to depart relating to the item includes leaving the item secured to the security device at the delivery destination.

12. The delivery system of claim 1, wherein the security device further comprises:
a tamper detector configured to detect at least one of an attempt to remove the security device from the item and tampering with the security device.

13. The delivery system of claim 1, wherein the security device further comprises:
a propulsion sub-system for moving the security device from the delivery destination after the robotic vehicle departs from the delivery destination; and
a sub-processor coupled to the propulsion sub-system and configured with processor-executable instructions to activate the propulsion sub-system to depart the delivery destination after the robotic vehicle has left from the delivery destination.

14. The delivery system of claim 1,
wherein the security device is a security tag attached to a portion of the item, and
wherein the security tag is configured to release the item upon authentication using the authenticating mechanism.

15. The delivery system of claim 1, wherein the security device includes a tamper-responsive device configured to disable, damage, or destroy the item.

16. The delivery system of claim 1, wherein the robotic vehicle processor is further configured with processor-executable instructions to:
activate the payload securing unit to release the item secured with the security device at the delivery destination and leave the item secured to the security device at the delivery destination without waiting to receive authorization to leave the item secured to the security device at the delivery destination.

17. A method of delivering an item via a robotic vehicle, comprising:
transporting the item secured to a security device by the robotic vehicle carrying the item to a delivery destination, wherein the security device is removable from the item using an authenticating mechanism and is configured to render the item unusable without authorized removal or deactivation of the security device;
releasing the item and the security device secured thereto at the delivery destination; and
operating the robotic vehicle to depart from the delivery destination prior to receiving authorization to depart relating to the item, wherein when departing from the delivery destination the robotic vehicle leaves the item secured to the security device at the delivery destination.

18. The method of claim 17, further comprising:
determining whether a presented authenticating mechanism, used to remove the security device from the item, is a valid authenticating mechanism, wherein determining whether the presented authenticating mechanism is the valid authenticating mechanism occurs after the robotic vehicle has departed from the delivery destination; and
activating a release mechanism for releasing the item from the security device in response to determining the presented authenticating mechanism is the valid authenticating mechanism.

19. The method of claim 17, wherein the security device is a security tag that releases the item upon authentication using the authenticating mechanism.

20. The method of claim 17, further comprising:
determining at least one of whether tampering with the security device has occurred and whether the security has been moved more than a predetermined distance from a drop-off position at the delivery destination; and
damaging the item in response to determining that tampering with the security device has occurred or that the security has been moved more than the predetermined distance from the drop-off position.

21. The method of claim 19, wherein the security device is a transport container enclosing the item therein.

22. The method of claim 17, further comprising:
transmitting a delivery notification to a recipient of the item in response to the robotic vehicle departing from the delivery destination.

23. The method of claim 21, wherein the transport container includes a plurality of separate compartments, wherein at least one of the separate compartments is configured to hold the item and at least one other of the separate compartments is configured to hold a different item for delivery.

24. The method of claim 21, further comprising:
transporting at least one other item, secured to another security device, by the robotic vehicle carrying the at least one other item to the delivery destination, wherein the other security device is removable from the at least one other item using another authenticating mechanism and makes the at least one other item unusable without removal of the other security device; and
operating the robotic vehicle to depart from the delivery destination without waiting for authorization to depart relating to the other item, wherein when departing from the delivery destination the robotic vehicle leaves the at least one other item secured to the other security device at the delivery destination.

25. The method of claim 19, further comprising:
transmitting at least one of a pass-code or specifications for making a physical key to a recipient of the item to be delivered to the delivery destination, wherein one of the pass-code or the physical key is the authenticating mechanism needed to remove the security device from the item.

26. The method of claim 19, further comprising:
detecting movement away from a drop-off position at the delivery destination of the security device with the item secured thereto after the robotic vehicle has departed from the delivery destination without the security device;
determining whether the security device has moved more than a predetermined distance from the drop-off position; and
activating an alert in response to determining that the detected movement moves the security device more than the predetermined distance from the drop-off position.

27. The method of claim 26, wherein activating the alert is further in response to:
determining that the item is still secured to the security device; and
determining that the security device has not been unlocked since the robotic vehicle arrived at the delivery destination.

28. The method of claim 19, further comprising:
detecting whether the security device has been tampered with after the robotic vehicle has departed from the delivery destination without the security device; and
activating an alert in response to determining that the security device has been tampered.

29. A processing device for a robotic vehicle, comprising:
a processor configured with processor-executable instructions to:
transport an item for delivery secured to a security device by the robotic vehicle carrying the item to a delivery destination, wherein the security device is removable from the item using an authenticating mechanism and is configured to render the item unusable without authorized removal or deactivation of the security device; and
operate the robotic vehicle to depart from the delivery destination prior to receiving authorization to depart relating to the item, wherein when departing from the delivery destination the robotic vehicle leaves the item secured to the security device at the delivery destination.

30. An item delivery system, comprising:
means for transporting an item for delivery to a delivery destination secured to a means for securing the item, wherein the means for securing the item is removable from the item using authenticating mechanism and is configured to render the item unusable without authorized removal or deactivation of the means for securing the item; and
means for operating the means for transporting the item to depart from the delivery destination prior to receiving authorization to depart relating to the item, wherein when departing from the delivery destination, the means for transporting the item leaves the item secured to the means for securing the item at the delivery destination.
